(19) United States
(12) Patent Application Publication
(10) Pub. No.: US 2009/0002317 A1
(43) Pub. Date: Jan. 1, 2009

(54) Joystick accessory for portable game console

(76) Inventors: Theo Stewart-Stand, Brooklyn, NY (US); Neal McLaughlin, Brooklyn, NY (US); John Vondracek, New York, NY (US)

Correspondence Address: K.F. ROSS P.C., 5683 RIVERDALE AVENUE, SUITE 203 BOX 900, BRONX, NY, 10471-0900, US

(21) Appl. No.: 11/823,631

(22) Filed: Jun. 28, 2007

(51) Int. Cl. G06F 3/033

(52) U.S. Cl. 345/161

(57) ABSTRACT

A game console has a housing having a front and back sides and near an edge of the housing on the front side an array of depressable game-operating buttons. A joystick accessory has a generally U-shaped clip having a front and rear legs and dimensioned to fit over the edge of the console with the front leg bearing on the front side adjacent the buttons and the rear leg bearing in the rear side. A rockable joystick projects forward from the front leg and has a rear end provided with respective actuating bumps aligned with the buttons. A bearing supports the joystick for pivotal movement on the front leg between a central position and with all of the formations out of operative engagement with the respective buttons and a plurality of tipped positions in each of which one of the formations is operatively engaged with the respective buttons.

### FIELD OF THE INVENTION

The present invention relates to a joystick accessory for a portable game console. More particularly this invention concerns such an accessory for a Sony PSP®.

### BACKGROUND OF THE INVENTION

A standard game console such as a Sony PSP® has a small housing adapted to be held in both hands. A front face of the housing has in its center a display, and to each side there is a group of four buttons in a polar array. The buttons serve the game and have standardized functions well known to an experienced gamer.

A principal disadvantage of such a system is that the buttons are not highly intuitive and for a person with less than excellent fine-motor skills are difficult to switch between and manipulate quickly and accurately, as is required for gaming. What is more, moving a finger from button to button to execute a move or action requires that the finger be lifted off one button and set accurately down on another, requiring excellent dexterity and, at best, taking some time.

### OBJECTS OF THE INVENTION

It is therefore an object of the present invention to provide an improved accessory easing use of such a portable game console.

Another object is the provision of such an improved accessory easing use of such a portable game console that overcomes the above-given disadvantages, in particular that allows the user to operate the buttons in a more intuitive and faster manner.

### SUMMARY OF THE INVENTION

The instant invention is therefore a joystick accessory used in combination with a game console having a housing having a front side and a back side and provided on the front side near an edge of the housing with an array of depressable game-operating buttons. The accessory according to the invention has a generally U-shaped clip having front and rear legs and dimensioned to fit over the edge of the console with the front leg bearing on the front side adjacent the buttons and the rear leg bearing in the rear side. A rockable joystick projects forward from the front leg and has a rear end provided with respective actuating formations aligned with the buttons. A bearing supports the joystick for pivotal movement on the front leg between a central position aligned with an axis and with all of the formations out of operative engagement with the respective buttons and a plurality of tipped positions in each of which a respective one of the formations is operatively engaged with the respective button. The term “operative engagement” here means bearing with enough force on one of the buttons to actuate it, that is to effect whatever action, e.g. a switch closing, that button does.

With this system, therefore, the accessory can be snapped onto the console by elastically deforming the clip. Once in place the user can manipulate the joystick in the manner many experienced gamers prefer, in that it involves continuous motions and does not require that the operating digit leave contact with the joystick that operates a plurality of buttons. The two arms are connected by a web and made of an elastically deformable material so they snugly grip the console and hold firmly in place thereon.

According to the invention there are four buttons on the console and the bearing can be moved angularly between the tipped positions. In addition the front leg has cutouts aligned with the buttons and through which the formations are engageable with the buttons.

One of the cutouts in accordance with the invention has a pair of parallel sides extending parallel to a plane including the axis. The respective formation, typically a rearwardly projecting bump unitarily formed on the joystick, has sides complementary to the cutout sides and fitting complementarily with the respective cutout sides so that the one formation and the respective cutout prevent the joystick from pivoting in the front leg about the axis.

Alternately one or all of the formations can be formed as a cup-shaped seat that fits complementarily over the respective button to prevent the joystick from pivoting by angularly coupling the joystick to the button or buttons. The ball-and-socket joint mounting the joystick can be made more like a universal joint so that, while permitting axial offset between its two sides, it prevents relative angular movement.

The bearing is a ball-and-socket joint, making it possible to move directly from a tipped position engaging one button to a position engaging one of the adjacent buttons without having to go through the neutral central position.

### BRIEF DESCRIPTION OF THE DRAWING

The above and other objects, features, and advantages will become more readily apparent from the following description, reference being made to the accompanying drawing in which:

FIGS. 1, 2, 3, and 4 are various perspective view of the joystick accessory according to the invention;

FIG. 5 is an end view taken in the direction of arrow V of FIG. 4 of the accessory;

FIG. 6 is a section taken along line VI-VI of FIG. 5;

FIG. 7 is a rear view of the clip of the accessory mounted on a schematically illustrated game console;

FIG. 8 is a perspective rear view of the mounted clip;

FIG. 9 is a front view of the mounted clip; and

FIGS. 10 and 11 are views taken in the direction of arrows X and XI of FIG. 9.

### SPECIFIC DESCRIPTION

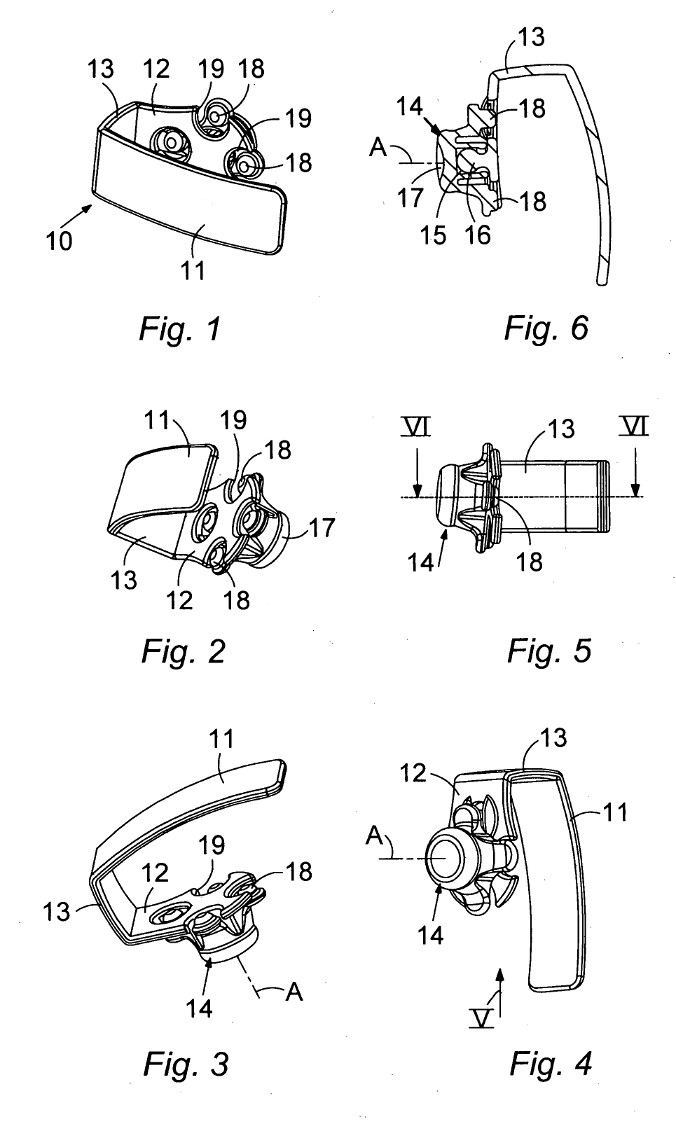

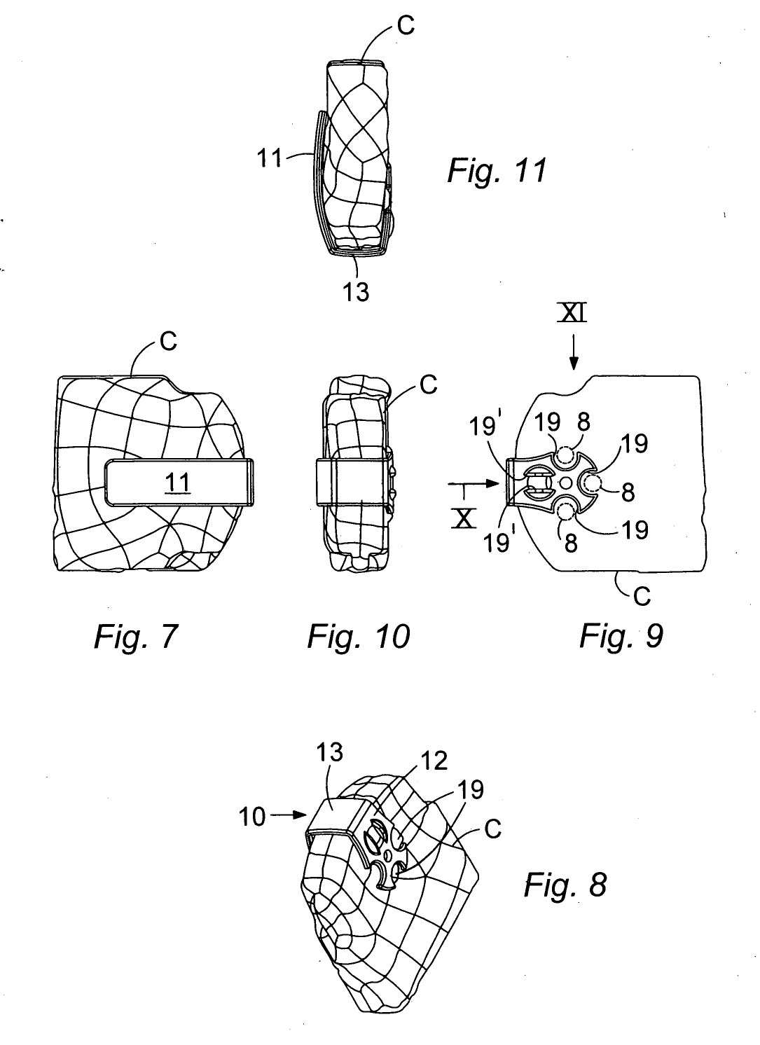

As seen in FIGS. 1-6 a joystick accessory 10 according to the invention basically comprises a U-shaped clip having an arcuate back leg 11 shaped to fit complementary with the back side of a game console C (FIGS. 8-11), here a Sony PSP®, a front leg 12 adapted to engage and fit complementarily against the console's front side at an array of four buttons B thereon, and a straight web 13 interconnecting the back leg 11 and front leg. The parts 11, 12, and 13 are unitarily formed of a durable but somewhat flexible plastic so the console C is solidly gripped between the back leg 11 and front leg 12, but the legs 11 and 13 can still be elastically spread enough for removal from and installation on the console C. FIGS. 8 through 11 illustrate how the clip formed by the parts 11-13 fits closely with the console C, so closely that it can stay on it without taking up any significant space. The front leg 12 engages around and exposes the buttons B as will be described below.

According to the invention a molded plastic joystick 14 is fitted to the front leg 12 and is held thereon typically centered on an axis A that in the installed position is centered between the buttons B. It is secured in place by a joint comprised of a socket 15 formed in a head 17 of the joystick 14 and a ball 16 fixed on and even unitarily formed with the front leg 12. The ball-and-socket joint 15, 16 therefore allows the entire joystick 14 to tip limitedly to all sides about the axis A, and even to nutate about a point on this axis A.

In addition the joystick 14 is formed spaced uniformly about the axis A with four formations or bumps 18 that project rearward through cutouts 19 in the front leg 12 and engage the buttons B of the console C. One of these cutouts 19 is a laterally closed hole that has a pair of flat sides 19′ (FIG. 9) extending parallel to and symmetrically flanking the axis A and the respective bump 18 has a pair of flat sides that slide on these sides 19′ and that prevent the joystick from pivoting about the axis A on the front leg 12. The other three cutouts are formed as radially outwardly open notches with part-circular bases. Thus the joystick 14 can tip to the side about the axis A, but cannot rotate on the leg 12 about this axis A.

We claim:

1. In combination with a game console having a housing having a front side and a back side and provided on the front side near an edge of the housing with an array of depressable game-operating buttons, an accessory comprising:
a generally U-shaped clip having front and rear legs and dimensioned to fit over the edge of the console with the front leg bearing on the front side adjacent the buttons and the rear leg bearing in the rear side;
a joystick projecting forward from the front leg and having a rear end provided with respective actuating formations aligned with the buttons; and
a bearing supporting the joystick for pivotal movement on the front leg between a central position aligned with an axis and with all of the formations out of operative engagement with the respective buttons and a plurality of tipped positions in each of which a respective one of the formations is operatively engaged with the respective button.

2. The joystick accessory defined in claim 1 wherein there are four buttons on the console and the bearing can be moved angularly between the tipped positions.

3. The joystick accessory defined in claim 1 wherein the front leg has cutouts aligned with the buttons and through which the formations are engageable with the buttons.

4. The joystick accessory defined in claim 1, further comprising means for preventing the joystick from twisting about the axis on the clip.

5. The joystick accessory defined in claim 4 wherein the means includes a pair of parallel sides extending parallel to a plane including the axis on one of the cutouts, the respective formation having sides complementary to the cutout sides and fitting complementarily with the respective cutout sides, whereby the one formation and the respective cutout prevent the joystick from pivoting in the front leg about the axis.

6. The joystick accessory defined in claim 1 wherein the bearing is a ball-and-socket joint.
